(19) United States
(12) Patent Application Publication
(10) Pub. No.: US 2011/0028254 A1
(43) Pub. Date: Feb. 3, 2011

(54) BELT DRIVE

(75) Inventors: Michael Bogner, Eckental (DE); Rainer Pflug, Heilsbronn (DE)

Correspondence Address: VOLPE AND KOENIG, P.C., UNITED PLAZA, 30 SOUTH 17TH STREET, PHILADELPHIA, PA, 19103, US

(73) Assignee: SCHAEFFLER TECHNOLOGIES GMBH & CO. KG, Herzogenaurach (DE)

(21) Appl. No.: 12/903,259

(22) Filed: Oct. 13, 2010

Related U.S. Application Data
(63) Continuation of application No. 11/201,698, filed on Aug. 11, 2005.
(60) Provisional application No. 60/604,110, filed on Aug. 24, 2004.

(30) Foreign Application Priority Data
Aug. 12, 2004 (DE) 102004039070.3

(51) Int. Cl. F16H 55/36; B21K 3/00

(52) U.S. Cl. 474/141; 29/888.01

(57) ABSTRACT

A belt drive is provided, especially a timing-belt drive for an internal-combustion engine, with a driving gear of a driveshaft, at least one driven gear of a driven shaft, and a belt means, wherein the driving or the driven gear imparts additional irregularity to the belt drive due to its noncircular shape and its phase position, which leads to stable running of the belt means. A noncircular gear that can be mounted easily and in phase, as well as with a fixed position, is realized in that the driving or driven noncircular gear has in its in-phase rotational position a rotationally fixed connection to its driving or driven shaft.

### CROSS-REFERENCE TO RELATED APPLICATIONS

This application is a continuation of U.S. application Ser. No. 11/201,698, filed Aug. 11, 2005, which claims the benefit of U.S. provisional Application 60/604,110, filed Aug. 24, 2004, and German Patent Application 10 2004 039 070.3, filed Aug. 12, 2004, all of which are incorporated by reference herein as if fully set forth.

### FIELD OF THE INVENTION

The invention relates to a belt drive, especially a timing-belt drive for an internal-combustion engine.

In the class-forming DE 195 20 508 A1, a belt drive for an internal-combustion engine is described, with a driving gear of a driveshaft, at least one driven gear of a driven shaft, and a belt drive means, wherein, due to its noncircular shape and its phase position, the driving gear or the driven gear imparts additional irregularity to the belt drive, which leads to stable running of the belt means.

The effectiveness of the noncircular gear depends on the exact setting of the phase position and its constancy. However, the above document lacks any indication on how the phase position of the noncircular gear is to be set and maintained.

### OBJECT OF THE INVENTION

The invention is based on the objective of providing a belt drive, in particular a timing-belt drive for an internal-combustion engine, whose noncircular gear necessary for stable running of the belt means can be mounted easily and in phase, as well as with a stable position.

### SUMMARY OF THE INVENTION

The objective is addressed according to the invention in that the driving gear or the driven gear which imparts additional irregularity to the belt drive due to its noncircular shape and its phase position and leads to stable running of the belt means, has in its in-phase rotational position a rotationally fixed connection to its driving or driven shaft

Because the noncircular gear in its in-phase rotational position has a rotationally fixed connection with its shaft, the in-phase rotational position is achieved and also held permanently easily and reliably.

It is advantageous that the rotationally fixed connection between the noncircular gear and its shaft is realized by a positive fit. This is especially suitable if precision in the setting and long service life are required.

It is also advantageous that the positive fit is achieved through corresponding, matching rotationally non-symmetric contact surfaces of the noncircular gear and the associated shaft. Since now there is only one possible way for assembly, the rotationally non-symmetric contact surfaces exclude incorrect assembly and therefore simplify the assembly of the timing-belt drive.

The object of the invention is also addressed by a further feature of the invention. After the driveshaft and the driven shaft have been positioned relative to each other, the in-phase rotational position of the noncircular gear is set with a setting device. This has the advantage that a conventional timing-belt drive can be retrofitted with a noncircular gear without high expense.

An advantageous setting device, which adapts to the geometry of the noncircular gear, is mounted or aligned on the engine and disassembled after the setting. An axial pin, for example, mounted eccentrically on the noncircular gear, or a corresponding bore can be used as a geometrical feature, which comes into contact with a complementary part of the setting device and thus fixes the in-phase rotational position of the noncircular gear.

The object of the invention is also addressed by further features of the invention, that is, by means of a visual setting aid. This is realized in that, after the driveshaft and the driven shaft are positioned relative to each other, a marking on the noncircular gear is brought into alignment with a counter marking. Then the noncircular gear is located in the in-phase rotational position relative to its shaft and is connected to this shaft.

It is advantageous if the counter marking is fixed relative to the engine and located on the crankcase or on a cover fixed to the crankcase.

An alternative visual setting aid is provided in that the counter marking is arranged on a shaft, that is, the shaft holding the marked noncircular gear. The counter marking can be arranged on the periphery of the shaft and in the axial direction or on the front side of the shaft and radially.

### BRIEF DESCRIPTION OF THE DRAWINGS

Additional features of the invention follow from the description below and the drawings, in which embodiments of the invention are shown schematically.

Shown are:

FIG. 1 is a view of a noncircular toothed belt gear with a central shaft bore, which has a wedge groove;

FIG. 1a is a longitudinal section through the noncircular toothed belt gear of FIG. 1;

FIG. 2 is a view of a noncircular toothed belt gear with an eccentric, axial bore for a catch pin;

FIG. 2a is a longitudinal section through the noncircular toothed belt gear of FIG. 2;

FIG. 3 is a view of a noncircular toothed belt gear with an eccentric bulge, which has radial and tangential guide surfaces;

FIG. 3a is a longitudinal section through the noncircular toothed belt gear of FIG. 3;

FIG. 4 is a view of a noncircular toothed belt gear with a shaft bore flattened on one side;

FIG. 4a is a longitudinal section through the noncircular toothed belt gear of FIG. 4;

FIG. 5 is a view of a noncircular toothed belt gear with a trapezoidal seat for a corresponding crankshaft end;

FIG. 5a is a longitudinal section through the noncircular toothed belt gear of FIG. 5;

FIG. 6 is a view of a noncircular toothed belt gear with an axial round pin in one of its teeth for fixing a setting device;

FIG. 6a is a longitudinal section through the noncircular toothed belt gear of FIG. 6;

FIG. 7 is a view of a noncircular toothed belt gear with a radial marking on one tooth and a counter marking, which is fixed relative to the engine and which is aligned in the set case;

FIG. 7a is a longitudinal section through the noncircular toothed belt gear of FIG. 7.

### DETAILED DESCRIPTION OF THE PREFERRED EMBODIMENTS

In today's conventional timing-belt drives, the assembly of the toothed belt gears is often realized through a friction fit by means of a press fit. This enables the equalization of tolerances, which is necessary, above all, in timing-belt drives.

At first, the driving crankshaft and the driven camshaft are positioned relative to each other. Then the driving and driven gears are placed on the crank-shaft and camshaft and the belt means are set. Then the crankshaft and the camshaft are connected to the driving gear and driven gear after successful tolerance compensation through a friction fit. Here, there is no positional allocation between the shafts and the gears. This results in no disadvantages, because the gears are round. However, the situation changes for noncircular gears, which must be mounted at a specific relative rotational position relative to their shaft.

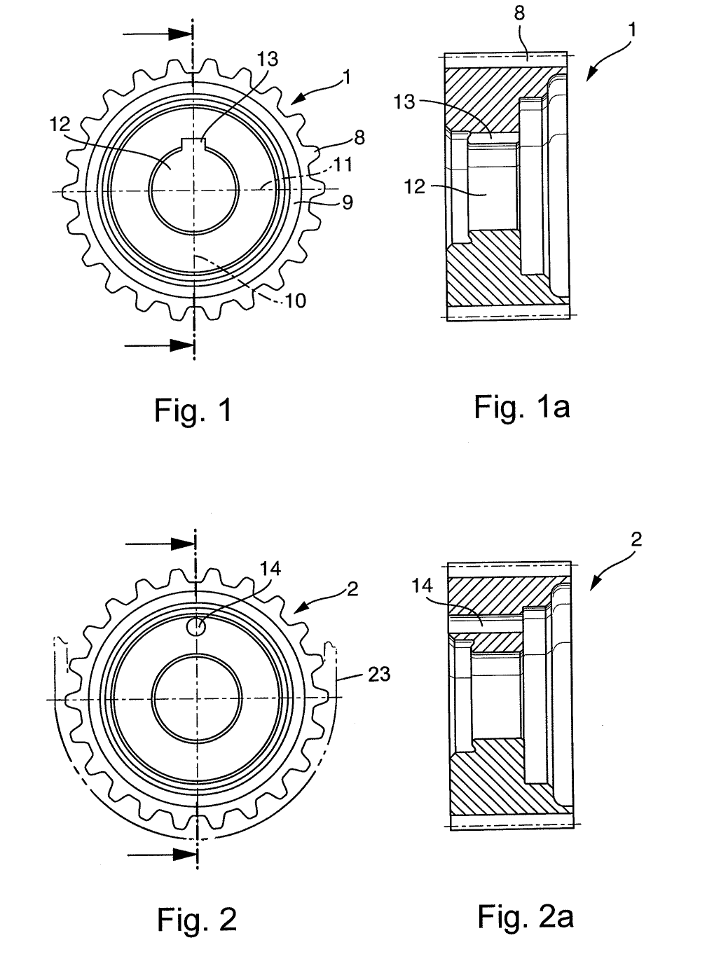

In FIGS. 1 to 7a, toothed belt gears 1 to 7 are shown. They are used as driving gears of a not-shown timing-belt drive of an internal-combustion engine. Their teeth 8 are arranged on an ellipse 9 with a major axis 10 and a minor axis 11. In this way, the required noncircular shape is achieved.

The gears 1 to 7 have differently shaped central openings. They are pushed onto a matching free end of a not-shown crankshaft and tightened to the crankshaft.

In order to achieve an in-phase rotational position relative to the crankshaft, there is a positive fit between the toothed belt gears 1 to 5 and the crankshaft. This is realized in various ways. The toothed belt gears 1 to 5 represent examples from an unlimited number of conceivable variants, which all satisfy the condition of rotationally non-symmetric contact surfaces.

The noncircular toothed belt gear 1 of FIGS. 1, 1a has a central bore 12 with an axial groove 13 for a groove-spring connection. The teeth 8 are arranged on an ellipse 9, which has a major axis 10 and a minor axis 11.

In the noncircular toothed belt gear 2 of FIGS. 2, 2a, there is an eccentric bore 14 for an axial pin, which is fixed in the front side of the crankshaft. The timing belt 23 is schematically shown in FIG. 2.

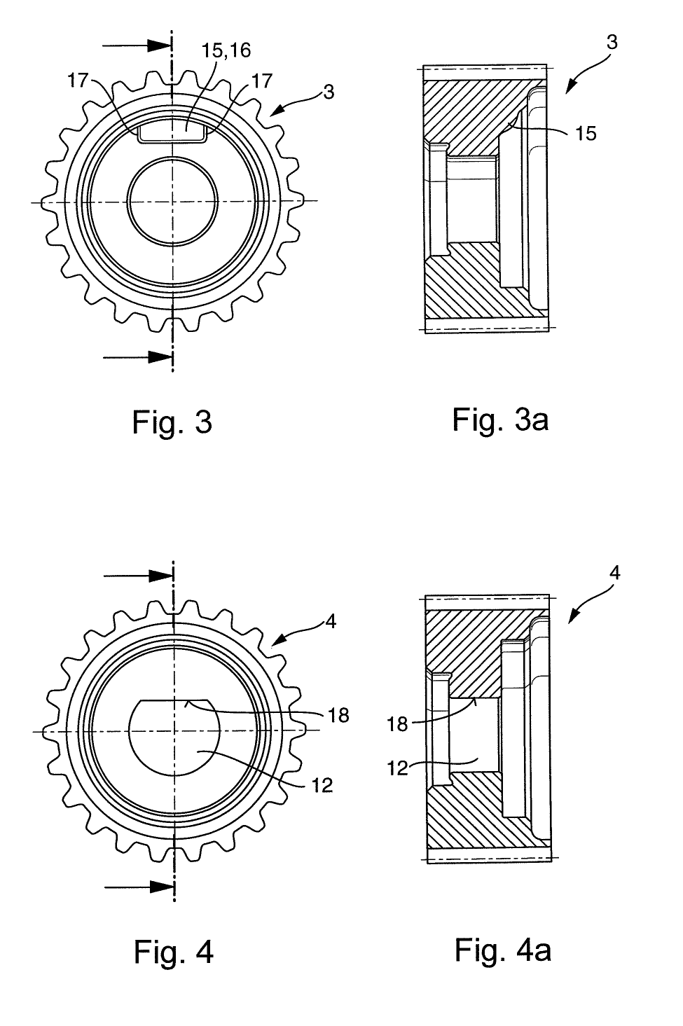

In the noncircular toothed belt gear 3 of FIGS. 3, 3a, an eccentric bulge 15 with one radial and two tangential guide surfaces 16, 17 is shown.

In the noncircular toothed belt gear 4 of FIGS. 4, 4a, there is a central bore 12 with a flattened section 18 on one side.

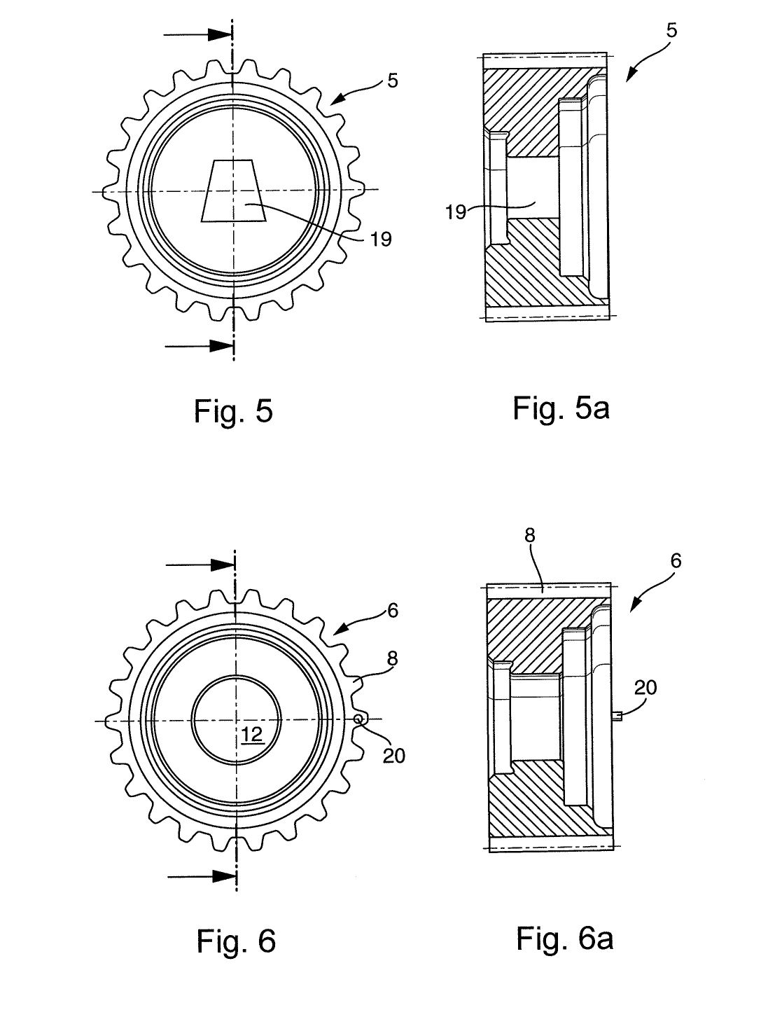

In the noncircular toothed belt gear 5 of FIGS. 5, 5a, there is a trapezoidal seat 19 for a correspondingly shaped crankshaft end.

The noncircular toothed belt gear 6 of FIGS. 6, 6a shows a smooth central bore 12 and an axial round pin 20, which projects from one of the teeth 8. It is used either as a visual marking for a counter marking on the crankcase of the internal-combustion engine or as a connection pin to a setting device screwed onto or attached to the crankcase for adjusting the phase position of the noncircular toothed belt gear 6.

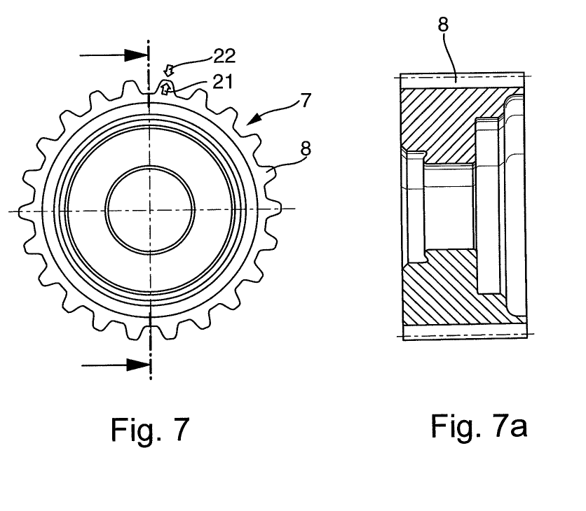

The in-phase rotational position of the noncircular toothed belt gear 7 of FIGS. 7, 7a is set exclusively through visual aids. A radial marking 21 on a tooth 8, which is aligned with a crankcase-fixed counter marking 22 in the in-phase rotational position, is used as such a visual aid.

The counter marking can also be mounted on the shaft holding the marked noncircular gear, that is, on the periphery of the shaft in the axial direction of this shaft or on its front side in the radial direction.

The assembly of a timing-belt drive with a noncircular gear differs from the assembly of a conventional timing-belt drive merely through the noncircular gear, which is aligned in a defined way relative to a driveshaft or driven shaft. All of the other gears can be assembled without being aligned and fixed with a friction fit after successful tolerance compensation.

### REFERENCE NUMBERS

1 Noncircular toothed belt gear

2 Noncircular toothed belt gear

3 Noncircular toothed belt gear

4 Noncircular toothed belt gear

5 Noncircular toothed belt gear

6 Noncircular toothed belt gear

7 Noncircular toothed belt gear

8 Tooth

9 Ellipse

10 Major axis

11 Minor axis

12 Central bore

13 Axial groove

14 Eccentric bore

15 Eccentric bulge

16 Radial guide surface

17 Tangential guide surface

18 Flattened section on one side

19 Trapezoidal seat

20 Axial round pin

21 Radial marking

11 Counter marking

23 Belt

1. A timing-belt drive of an internal-combustion engine, comprising a driving gear of a driveshaft, at least one driven gear of a driven shaft, and a belt, wherein the driving gear or the driven gear imparts additional irregularity to the belt due to a noncircular shape and a phase position thereof, which leads to stable running of the belt, the driving or driven noncircular gear has in an in-phase rotational position a rotationally fixed connection to the driving or driven shaft, the in-phase rotational position is indicated by a visual position reference formed by a marking on the noncircular gear and a counter marking on the engine which provides the in-phase rotational position when the marking and the counter marking are aligned with one another.

2. Belt drive according to claim 1, wherein the counter marking is arranged on a crankcase or on a cover mounted on the crankcase.

3. Belt drive according to claim 1, wherein the counter marking is arranged on the shaft holding the marked noncircular gear.

4. Method for installing a timing-belt drive of an internal-combustion engine, comprising a driving gear of a driveshaft, at least one driven gear of a driven shaft, and a belt, wherein the driving gear or the driven gear imparts additional irregularity to the belt due to a noncircular shape and a phase position thereof, which leads to stable running of the belt, the method comprising for positioning the driving or driven noncircular gear in an in-phase rotational position on the driving or driven shaft, aligning a visual position reference formed by a marking on the noncircular gear with a counter marking, and then fixing the driving or driven noncircular gear in the in-phase rotational position with the corresponding driveshaft or driven shaft.

5. The method of claim 4, further comprising providing the counter marking on a crankcase or on a cover mounted on the crankcase.

6. The method of claim 4, further comprising arranging the countermarking on the shaft holding the noncircular gear.
